(19) United States
(12) Patent Application Publication
(10) Pub. No.: US 2014/0062802 A1
(43) Pub. Date: Mar. 6, 2014

(54) ELECTRONIC SHELF LABEL

(71) Applicant: SAMSUNG ELECTRO-MECHANICS CO., LTD., Suwon (KR)

(72) Inventors: Jeong Sik SEO, Suwon (KR); Hyun Hak KIM, Suwon (KR); Ju Hyung KIM, Suwon (KR); Im Yong PARK, Suwon (KR); Chang Mok HAN, Suwon (KR)

(73) Assignee: SAMSUNG ELECTRO-MECHANICS CO., LTD., Suwon (KR)

(21) Appl. No.: 13/962,582

(22) Filed: Aug. 8, 2013

(30) Foreign Application Priority Data
Aug. 29, 2012 (KR) 10-2012-0095196

(51) Int. Cl. H01Q 1/24

(52) U.S. Cl. CPC H01Q 1/24
USPC 343/702

(57) ABSTRACT

There is provided an electronic shelf label having an improved signal reception rate by implementing an antenna receiving a signal in a patch form on a surface of a device. The electronic shelf label includes: a case; a receiving unit provided in the case to receive and process a wireless signal including product information and including a patch antenna at least partially embedded in the case to receive the wireless signal; and a display unit provided in the case and at least partially opened to an exterior of the case to display the product information.

### CROSS-REFERENCE TO RELATED APPLICATIONS

This application claims the priority of Korean Patent Application No. 10-2012-0095196 filed on Aug. 29, 2012, in the Korean Intellectual Property Office, the disclosure of which is incorporated herein by reference.

### BACKGROUND OF THE INVENTION

1. Field of the Invention

The present invention relates to an electronic shelf label having an improved signal reception rate.

2. Description of the Related Art

In a store that sells various kinds of products in large quantities, such as a department store, a superstore, or the like, a large number of product display stands are commonly installed and various products arranged in types thereof are displayed thereon.

In addition, a display tag in which information such as a name, a price, and further information related to a product is recorded has been adhered or placed on a front surface of the display stand on which products are displayed to allow a consumer to purchase a desired product.

However, in accordance with a gradual increase in store sizes, a kind and an amount of products requiring management have been increased. Therefore, it has been practically impossible for an administrator to directly manage the manual alteration of prices of all products displayed within a store, as in the related art.

In order to solve this problem, research into technology for introducing an electronic shelf label (ESL) to manage information related to various products through an electronic control device and transmit the information to the electronic shelf label displaying corresponding products in a wireless communications scheme has been recently actively undertaken.

Electronic shelf labels have been widely used in superstores, and the like, since it is very easy to manage a large number of products, in that the electronic shelf labels may be collectively managed by a single system collectively managing the electronic shelf labels as disclosed in the following Related Art Document. However, since a number of electronic shelf labels may now be used in a large area, a reception rate of a signal transmitting the information on the product should be managed.

### Related Art Document

### (Patent Document 1) Korean Patent Laid-Open Publication No. 10-2012-0128906

### SUMMARY OF THE INVENTION

An aspect of the present invention provides an electronic shelf label having an improved signal reception rate by implementing an antenna receiving a signal in a patch form on a surface of a device.

According to an aspect of the present invention, there is provided an electronic shelf label including: a case; a receiving unit provided in the case to receive and process a wireless signal including product information and including a patch antenna at least partially embedded in the case to receive the wireless signal; and a display unit provided in the case and at least partially opened to an exterior of the case to display the product information.

The patch antenna may be a circularly polarized patch antenna.

The electronic shelf label may further include a printed circuit board disposed in the case and having the display unit mounted thereon.

The receiving unit may further include a signal processing circuit mounted on a printed circuit board.

The printed circuit board may include a ground pattern stabilizing the received wireless signal.

The ground pattern may be disposed in a position facing the patch antenna on a surface of the printed circuit board.

The patch antenna may be embedded in a surface of the case in an in-mold-antenna (IMA) scheme.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of a general electronic shelf labeling system;

FIGS. 2A through 2D are views showing an electronic shelf label according to the embodiment of the present invention;

FIGS. 3 and 4 are views showing antenna characteristics of the electronic shelf label according to the embodiment of the present invention shown in FIG. 2B; and

FIG. 5 is a view showing antenna characteristics of an electronic shelf label according to another embodiment of the present invention shown in FIG. 2D.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same or like reference numerals will be used to designate the same or like elements.

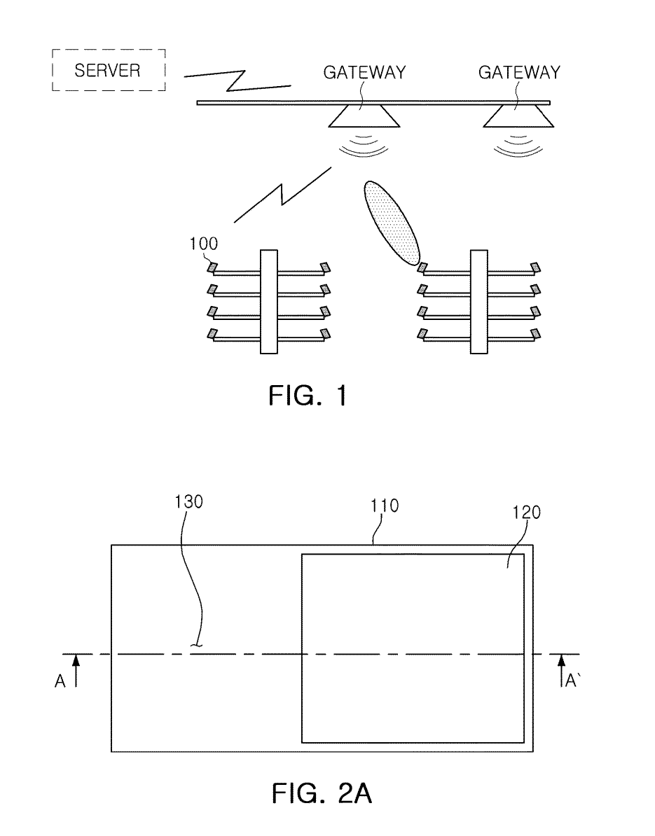

FIG. 1 is a configuration diagram of a general electronic shelf labeling system.

Referring to FIG. 1, a general electronic shelf labeling system may include a server managing set product information and controlling transmission of the product information, gateways relaying the product information transmitted from the server to electronic shelf labels 100 in a set region, and the electronic shelf labels 100 receiving the product information from the gateway and displaying the same.

As shown in FIG. 1, a plurality of electronic shelf labels may be disposed in a large area such as a superstore, and the product information may be wirelessly transmitted from a position above the electronic shelf labels, such as from a ceiling of the store, in order to efficiently manage the transmission of the product information to the electronic shelf labels.

Therefore, there is a need to improve a reception rate of a wireless signal transmitted from the position above the electronic shelf label, such as from the ceiling of the store.

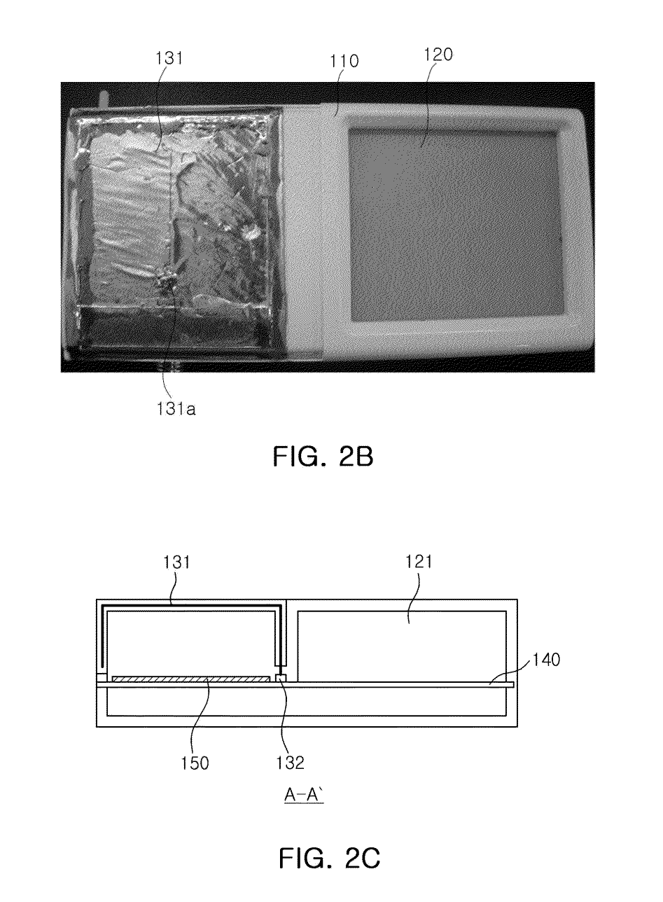

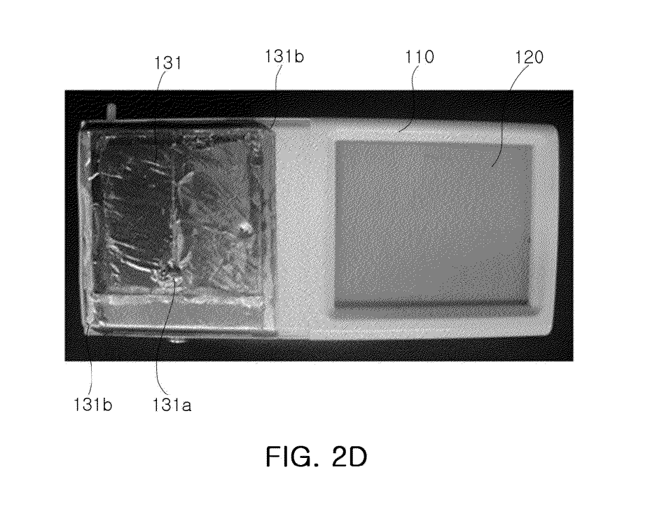

FIGS. 2A through 2D are views showing an electronic shelf label according to an embodiment of the present invention.

FIG. 2A is a plan view showing the electronic shelf label according to the embodiment of the present invention; FIG. 2B is a plan view in which the electronic shelf label according to the embodiment of the present invention is partially opened; FIG. 2C a cut-away view of the electronic shelf label of FIG. 2A, taken along line A-A′; and FIG. 2D is a plan view in which the electronic shelf label is partially opened according to another embodiment of the present invention.

Referring to FIGS. 2A through 2C, the electronic shelf label 100 according to the embodiment of the present invention may include a case 110, a display unit 120, and a receiving unit 130.

The case 110 may have a mounting region formed therein and have a surface capable of surrounding the mounting region having a predetermined thickness. Further, the case 110 may be partially opened in a region in which the display unit 120 is formed.

The display unit 120 may include a display module 121 mounted on a printed circuit board (PCB) 140 formed in the case 110 and may display product information received through the receiving unit 130. To this end, the display unit 120 may be partially opened in the opened region of the case 110 to thereby display the received product information to the outside.

The receiving unit 130 may include an antenna 131 and a signal processing circuit 132.

The antenna 131 may be a patch antenna having a feeding point 131a as shown in FIG. 2B and may be partially embedded in the surface of the case 110. The antenna 131 may be embedded in the surface of the case 110 in an in-mold-antenna (IMA) scheme. The antenna 131 may have one side connected to the signal processing circuit 132 to transfer the received wireless signal to the signal processing circuit 132.

The signal processing circuit 132 may be mounted on the printed circuit board 140 and acquire the product information from the received wireless signal to transfer the product information to the display unit 120 so as to be displayed.

The printed circuit board 140 provided in the mounting region of the case 110 may have a circuit pattern formed on at least one surface thereof and have the signal processing circuit 132 and the display module 121 mounted on the surface thereof. Further, a ground pattern 150 may be formed on the surface of the printed circuit board 140 in order to stabilize reception of the wireless signal.

The wider the area of the ground pattern 150 is, the more stable the reception of the wireless signal is. However, in this case, a circuit area may be increased, leading to a volume of the product being increased. In the electronic shelf label 100 according to the embodiment of the present invention, the antenna 131 may be embedded in the surface of the case 110 to increase the area of the ground pattern 150 while decreasing the volume of the product. Therefore, the ground pattern 150 may be formed in a region of the surface of the printed circuit board 140 facing the antenna 131. Furthermore, the antenna 131 is embedded in the surface of the case 110, such that components of the signal processing circuit 132 may be easily disposed.

Referring to FIG. 2D, in the electronic shelf label 100 according to another embodiment of the present invention, in the case 110 having the display unit 120 and the receiving unit 130, the antenna 131 of the receiving unit 130 may have a feeding unit 131a and be a circularly polarized patch antenna having a form in which corners at a left upper end and a right lower end are cut.

As described above, since the plurality of electronic shelf labels are disposed in a large area such as a superstore and the product information is wirelessly transmitted from above the electronic shelf label, such as from the ceiling of the store, in order to efficiently manage the transmission of the product information to the electronic shelf label, in order to stably receive a wireless signal such as a Zigbee wake-up signal or a Zigbee data signal that may be reflected or refracted by an indoor display stand or other products to thereby be horizontally polarized, vertically polarized, and polarized at various angles, the above-described circularly polarized patch antenna may be advantageous.

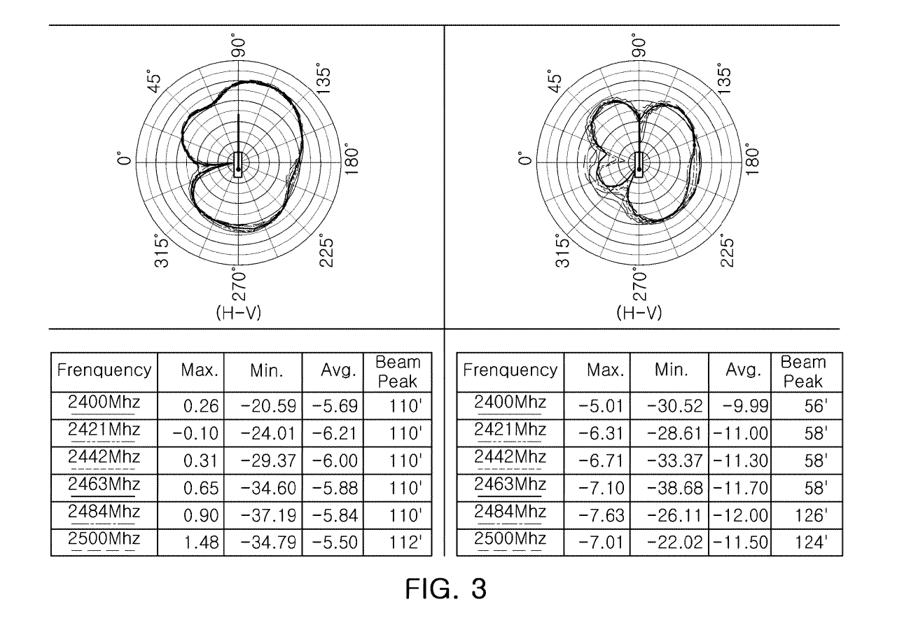

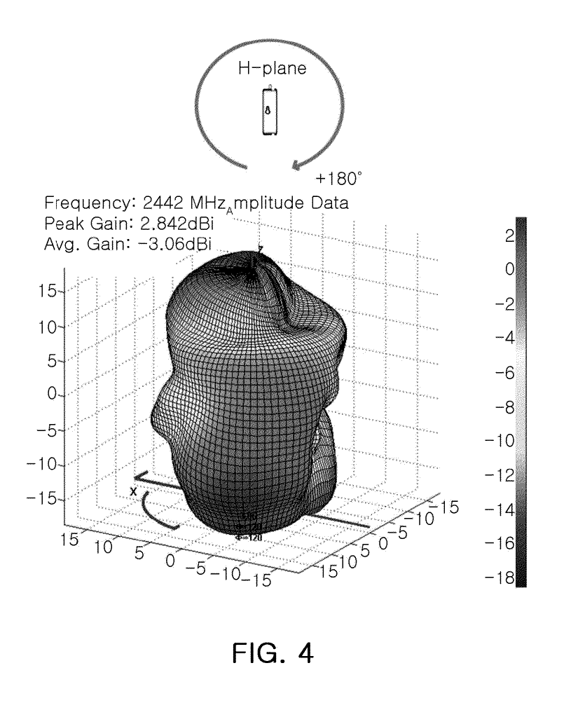

FIGS. 3 and 4 are views showing antenna characteristics of the electronic shelf label according to the embodiment of the present invention shown in FIG. 2B.

Referring to FIGS. 2B, 3, and 4, the antenna 131 may be implemented in the patch antenna form to allow a beam to be concentrated toward the front of the electronic shelf label and the upper side in which the gateway is installed.

As an example, a 2.4 GHz band antenna may have a size calculated as approximately 3.2 cm*3.2 cm and have a size of 3.5 cm*4.2 cm by tuning at the time of being actually formed.

A length of the patch antenna in a horizontal direction may determine a degree of radiation and a length thereof in a vertical direction may control a frequency.

Referring to FIGS. 3 and 4, in the electronic shelf label according to embodiment of the present invention, it may be seen that the beam is formed toward the front surface and the upper surface rather than the side surfaces that are not required to receive the signal, which may be advantageous for transmitting and receiving the wireless signal.

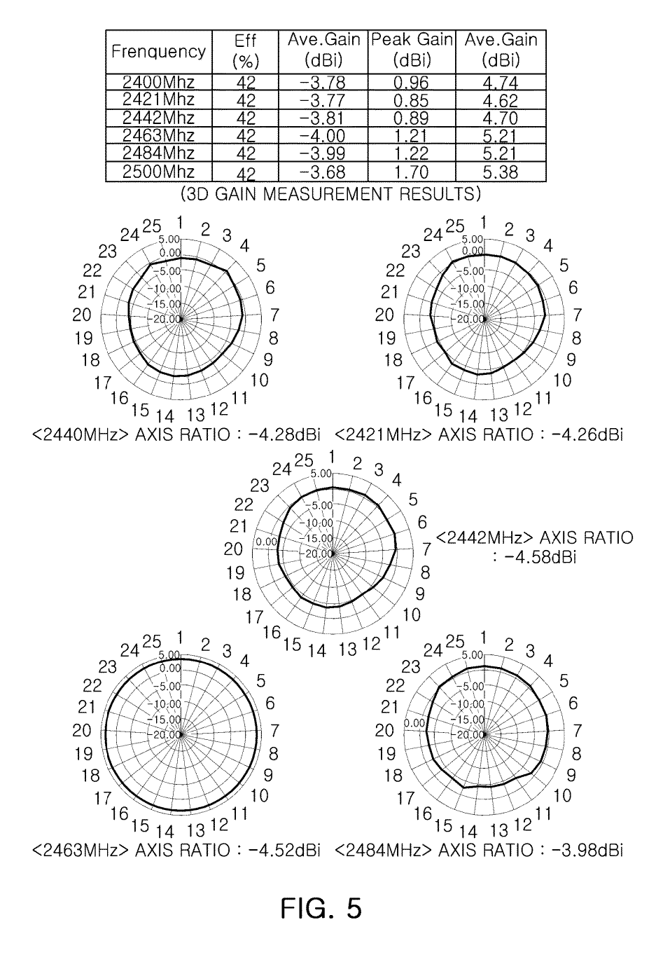

FIG. 5 is view showing antenna characteristics of an electronic shelf label according to another embodiment of the present invention shown in FIG. 2D.

Referring to FIG. 5, it may be seen that a satisfactory axis ratio is maintained within −5 dB and the axis ratio bandwidth is maintained from 2400 MHz to 2484 MHz, that is, is maintained as 84 MHz.

As described above, according to the embodiment of the invention, the antenna receiving the signal is implemented in a patch form in which it is embedded in the surface of the device to form a wide ground pattern without increasing a volume of the product, whereby the signal transferred from the gateway may be stably received. In addition, the antenna is formed as a circularly polarized patch antenna, whereby a reception rate of a signal transferred from a gateway installed on an indoor ceiling, or the like, may be improved.

As set forth above, according to the embodiments of the invention, the antenna receiving the signal is implemented in the patch form on the surface of the device, whereby the reception rate of the signal transferred from the gateway may be improved.

While the present invention has been shown and described in connection with the embodiments, it will be apparent to those skilled in the art that modifications and variations can be made without departing from the spirit and scope of the invention as defined by the appended claims.

What is claimed is:

1. An electronic shelf label comprising:
a case;
a receiving unit provided in the case to receive and process a wireless signal including product information and including a patch antenna at least partially embedded in the case to receive the wireless signal; and
a display unit provided in the case and at least partially opened to an exterior of the case to display the product information.

2. The electronic shelf label of claim 1, wherein the patch antenna is a circularly polarized patch antenna.

3. The electronic shelf label of claim 1, further comprising a printed circuit board disposed in the case and having the display unit mounted thereon.

4. The electronic shelf label of claim 2, wherein the receiving unit further includes a signal processing circuit mounted on a printed circuit board.

5. The electronic shelf label of claim 4, wherein the printed circuit board includes a ground pattern stabilizing the received wireless signal.

6. The electronic shelf label of claim 5, wherein the ground pattern is disposed in a position facing the patch antenna on a surface of the printed circuit board.

7. The electronic shelf label of claim 1, wherein the patch antenna is embedded in a surface of the case in an in-mold-antenna (IMA) scheme.
